(19) United States
(12) Patent Application Publication
(10) Pub. No.: US 2024/0177091 A1
(43) Pub. Date: May 30, 2024

(54) INFORMATION PROCESSING APPARATUS, INFORMATION PROCESSING METHOD, AND RECORDING MEDIUM

(71) Applicant: NEC Corporation, Tokyo (JP)

(72) Inventor: Osamu Nishimura, Tokyo (JP)

(73) Assignee: NEC Corporation, Tokyo (JP)

(21) Appl. No.: 18/510,966

(22) Filed: Nov. 16, 2023

(30) Foreign Application Priority Data
Nov. 24, 2022 (JP) 2022-187168

(51) Int. Cl. G06Q 10/0631

(52) U.S. Cl. CPC G06Q 10/06315

(57) ABSTRACT

An information processing apparatus includes a memory storing instructions, and storing store data including the number of unpaid customers who are unpaid in a store, the number of operating payment devices, and the number of waiting customers who are waiting for payment in a payment devices, at each of a plurality of time points, and one or more processors configured to execute the instructions to acquire the number of currently operating payment devices, calculate the number of currently unpaid customers based on the sensor data of the store, specify past store data in which the number of unpaid customers and the number of operating payment devices similar to the number of currently unpaid customers and the number of currently operating payment devices are associated with each other, and determine the number of required payment devices based on the specified store data.

This application is based upon and claims the benefit of priority from Japanese Patent Application No. 2022-187168, filed on Nov. 24, 2022, the disclosure of which is incorporated herein in its entirety by reference.

### TECHNICAL FIELD

The present invention relates to an information processing apparatus, an information processing method, a recording medium storing an information processing program, and the like.

### BACKGROUND ART

Japanese Patent Application Laid-open Publication No. 2021-114221 disclosures a technology of predicting a congestion status of a payment device and calculating a recommended number of payment devices according to the congestion status by performing simulation or machine learning based on the number of customers visiting the store, the number of customers leaving the store, the number of waiting people for the payment device, the number of people passing through the payment device, and customer attributes.

### SUMMARY

An object of the present disclosure is to provide a technology for performing demand prediction of the number of operating devices of the payment devices while suppressing a load of arithmetic processing.

According to an aspect of the present disclosure, there is provided an information processing apparatus including: a storage means that stores store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points; an acquisition means that acquires the number of currently operating devices; a calculation means that calculates the number of currently unpaid people based on the sensor data of the store; a specifying means that specifies past store data in which the number of unpaid people and the number of operating devices similar to the number of currently unpaid people and the number of currently operating devices are associated with each other; and a determination means that determines the number of required devices which is the number of required payment devices based on the specified store data.

According to another aspect of the present disclosure, there is provided an information processing method by a computer storing, in a storage unit, store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points, the information processing method including: acquiring the number of currently operating devices; calculating the number of currently unpaid people based on the sensor data of the store; specifying past store data in which the number of unpaid people and the number of operating devices similar to the number of currently unpaid people and the number of currently operating devices are associated with each other; and determining the number of required devices which is the number of required payment devices based on the specified store data.

According to still another aspect of the present disclosure, there is provided a recording medium that stores a program for causing a computer communicably connected to a storage unit storing store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points, to execute; acquiring the number of currently operating devices; calculating the number of currently unpaid people based on the sensor data of the store; specifying past store data in which the number of unpaid people and the number of operating devices similar to the number of currently unpaid people and the number of currently operating devices are associated with each other; and determining the number of required devices which is the number of required payment devices based on the specified store data.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration of a system including an information processing apparatus;

FIG. 2 is a block diagram illustrating a functional configuration of the information processing apparatus;

FIG. 3 is a diagram illustrating an example of store data;

FIG. 4 is a diagram illustrating an example of current store data;

FIG. 5 is a diagram illustrating an output example;

FIG. 6 is a flowchart illustrating an operation of the information processing apparatus;

FIG. 7 is a flowchart illustrating the operation of the information processing apparatus; and

FIG. 8 is a diagram illustrating a hardware configuration in which the information processing apparatus according to the present disclosure is implemented by a computer device and peripheral devices of the computer device.

### EXAMPLE EMBODIMENT

Next, an example embodiment of the present disclosure will be described in detail with reference to the drawings.

The present disclosure relates to a technology for performing demand prediction of the number of operating devices of payment devices in a retail store. An information processing apparatus, an information processing method, and a program according to the present disclosure perform the demand prediction of the number of operating devices of the payment devices based on information on a store. Examples of the retail store include, but are not particularly limited to, a supermarket, a convenience store, a drug store, an apparel shop, an electric appliance mass retailer, a home center, and the like. The payment device is a device that makes payment when a customer who uses a retail store purchases a product. The payment device is, for example, a POS (Point Of Sales) terminal. In the present disclosure, the payment device is assumed to be, for example, a payment device that requires an operation of a clerk. That is, the payment device in the present disclosure may be a payment device in which a clerk handles from registration to payment of a purchased product, or a payment device in which a clerk registers only a purchased product. The payment device is not limited thereto.

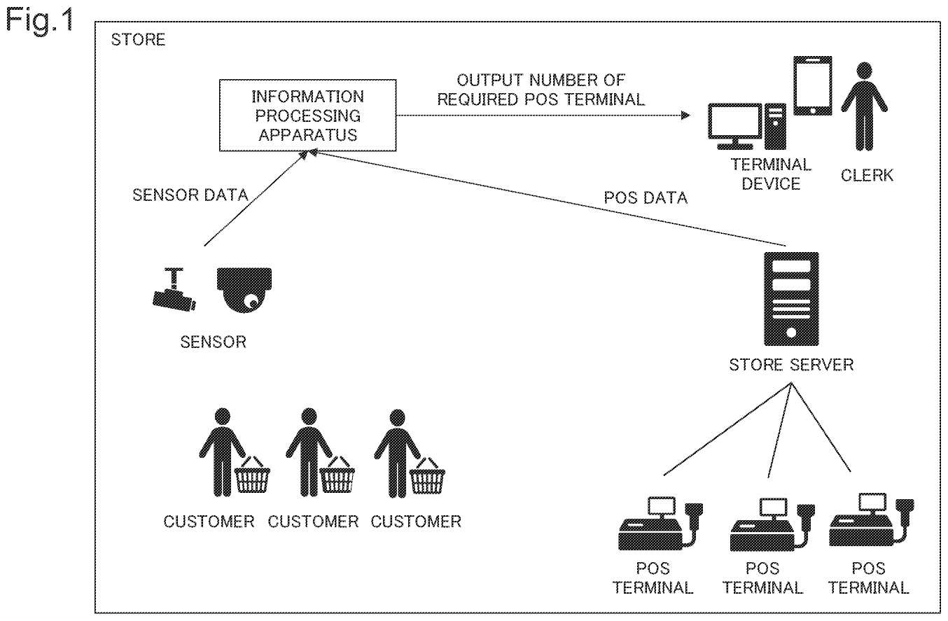

FIG. 1 is a diagram illustrating an example of a system including an information processing apparatus of the present disclosure.

In FIG. 1, the information processing apparatus acquires sensor data and POS data as store information from a sensor of a store or a POS terminal of the store. The sensor of the store is, for example, a sensor provided at the entrance of the store and configured to detect the number of customers staying in the store. The sensor may be, for example, a human sensor or a camera. However, the type of the sensor is not particularly limited as long as the number of customers entering and exiting the store or the number of customers staying in the store can be detected. As illustrated in FIG. 1, the information processing apparatus may acquire store information from a POS terminal via a store server that collects POS data of a store. The inside of the store may include not only a sales room of the store or a building including the sales room but also, for example, a parking lot of the store.

The information processing apparatus predicts the demand for the number of operating devices. Then, as a result of the demand prediction, the information processing apparatus causes a terminal device in the store to output the required number of payment devices, the number of recommended devices, the instruction to increase the number of clerks, or the instruction to decrease the number of clerks. The terminal device in the store is not particularly limited as long as the terminal device is a device that outputs the required number of payment devices, the number of recommended devices, the instruction to increase the number of clerks, or the instruction to reduce the number of clerks such that the clerk can recognize the terminal device.

In FIG. 1, the information processing apparatus is provided in the store. The information processing apparatus may be provided outside the store and communicably connected to a sensor, a POS terminal, and a terminal device in the store. The information processing apparatus may be included in the store server. The store server including the information processing apparatus may be provided outside the store and communicably connected to the sensor, the POS terminal, and the terminal device in the store.

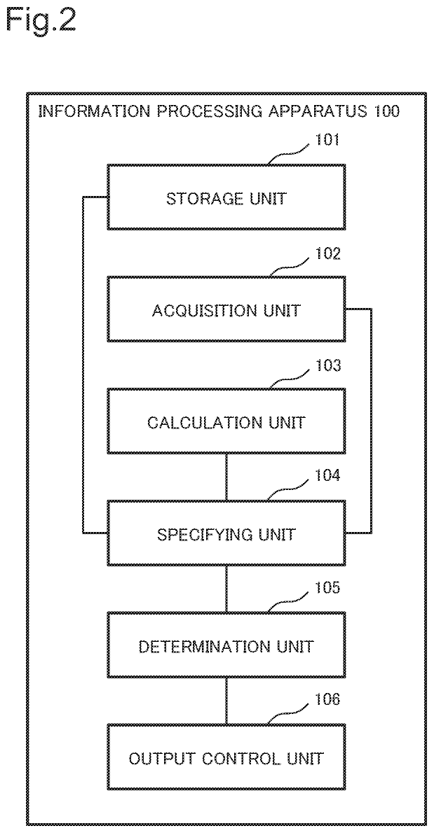

Next, a configuration of the information processing apparatus 100 according to the example embodiment will be described with reference to FIG. 2. The information processing apparatus 100 includes a storage unit 101, an acquisition unit 102, a calculation unit 103, a specifying unit 104, and a determination unit 105. The information processing apparatus 100 may include an output control unit 106. FIG. 2 is a block diagram illustrating a configuration in a case where the information processing apparatus 100 includes the output control unit 106.

Next, a configuration of the information processing apparatus 100 according to the example embodiment will be described in detail.

In FIG. 2, the storage unit 101 is an example of a storage means that stores store data including the number of unpaid people, which is the number of customers who are unpaid in the store, the number of operating devices, which is the number of operating payment devices, and the number of waiting people, which is the number of customers who are waiting for payment in the payment devices, at each of a plurality of time points. The number of unpaid people is the number of people who stay in the store and have not completed payment. The number of unpaid people may be obtained by subtracting the number of customers who are in the store but have already completed payment from the number of customers in the store at a certain time point. The number of customers in the store and the number of customers who have already completed payment for obtaining the number of waiting people waiting and the number of unpaid people may be detected based on, for example, sensor data in the store. The number of operating payment devices may be detected based on the POS data.

The store data stored in the storage unit 101 is collected in advance in a store that performs the demand prediction of the number of operating devices of the payment devices. Alternatively, the store data stored in the storage unit 101 may be collected in a store similar to a store that performs demand prediction of the number of operating devices of the payment devices. The similar store may be a store in which various conditions related to the number of users of the store are similar. The condition may be, for example, a population around the store, a competing store around the store, a distance from the nearest station to the store, a traffic volume on a road around the store, or the like. The store data stored in the storage unit 101 is, for example, store data for one month. The store data may be appropriately collected by an existing method.

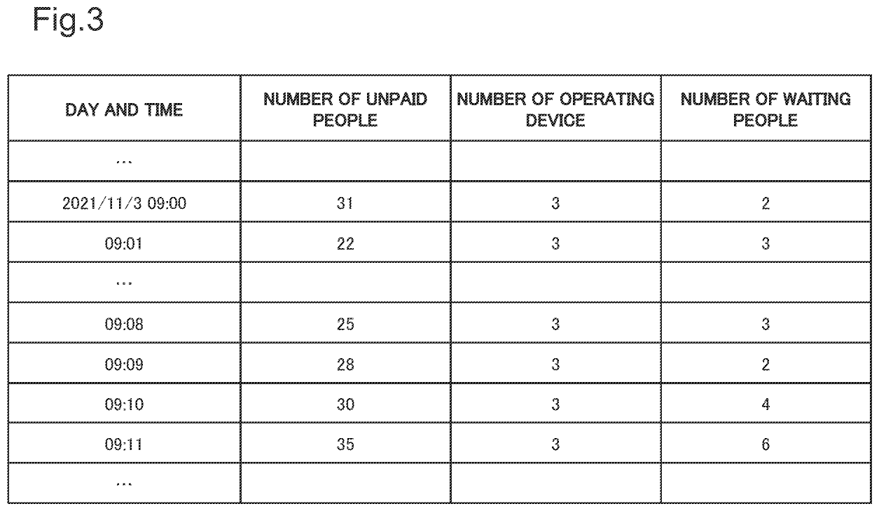

FIG. 3 is an example of store data stored in the storage unit 101. The store data includes a date and time representing a plurality of time points. In FIG. 3, the store data is data every minute, but the present invention is not limited thereto. The store data may store data acquired at intervals necessary for determining the required number of payment devices. The store data may be, for example, data every 10 seconds, every 30 seconds, every 5 minutes, or the like. The store data includes the number of unpaid people, the number of operating devices of the payment devices, and the number of waiting people for payment devices.

The acquisition unit 102 is an example of an acquisition means that acquires the number of currently operating devices. The acquisition unit 102 acquires the POS data, and acquires the number of currently-operating payment devices based on the POS data.

The calculation unit 103 is an example of a calculation means for calculating the number of currently unpaid people based on the sensor data of the store. The calculation unit 103 may calculate the number of currently unpaid people based on the POS data in addition to the sensor data. For example, the sensor data is data detected by a human sensor installed at an entrance of the store or data in which a person included in an image captured by a camera is detected. Specifically, the calculation unit 103 calculates a total value of the number of store visitors from the time of opening from the sensor data. The calculation unit 103 acquires the number of times of payment completion of each payment device from the POS data, and calculates a total value of the number of times of payment completion from the time of opening. Then, the calculation unit 103 calculates the number of unpaid people by subtracting the total value of the number of times of payment completion from the time of opening from the total value of the number of customers who enters the store from the time of opening. Alternatively, the calculation unit 103 may calculate the number of unpaid people by subtracting a number obtained by multiplying the total value of the number of times of payment completion from the time of opening by the number of passing people of the payment device per payment from the total value of the number of customers who enters the store from the time of opening. The number of passing people per payment may be a general average value or an average value in a store. The number of passing people per payment may be set for each time zone. That is, the calculation unit 103 calculates the number of unpaid people using a value based on the number of times of completion of payment by the payment device that can be acquired from the POS data as the predicted value of the number of people who have completed payment at the store.

The calculation unit 103 may calculate the number of unpaid people by a method other than the above-described method. In this case, the calculation unit 103 may calculate the number of unpaid people by detecting the number of customers who are at the store and have completed payment with the sensor. The calculation unit 103 may calculate the number of unpaid people by subtracting the number of people included on a traffic line until the people leaves the store after the payment based on the sensor data of the store from the number of people in the store as the number of people who are in the store and have completed the payment. The number of people in the store may be obtained, for example, by subtracting the number of customers who have left the store at the time of opening from the number of people who have entered the store at the time of opening.

The method of calculating the number of unpaid people by the calculation unit 103 may be different from the method of calculating the number of unpaid people when the store data stored in the storage unit 101 is collected. For example, the number of unpaid people may be more reliably calculated using the number of people who have completed payment detected at the time of collection of store data, and may be easily calculated using the number of people who have completed payment predicted based on the POS data at the time of performing demand prediction of the number of operating devices of the payment devices. As a result, it is possible to reduce the load of arithmetic processing in the demand prediction of the number of operating devices of the payment devices.

The specifying unit 104 is an example of a specifying means that specifies past store data in which the number of unpaid people and the number of operating devices are associated, the data being similar to the number of currently unpaid people and the number of currently operating devices. The number of currently unpaid people and the number of currently operating devices may be the latest one of the calculated number of unpaid people and the acquired number of operating devices. The specifying unit 104 refers to the storage unit 101 to specify past store data in which the number of unpaid people and the number of operating devices that are similar to the number of operating devices acquired by the acquisition unit 102 and the number of unpaid people calculated by the calculation unit 103 are associated with each other. For example, the specifying unit 104 specifies past store data in which the number of operating devices is the same as the number of currently operating devices and a difference from the number of currently unpaid people is within an error range. The error range may be set in advance by the number of people or a ratio, such as between minus 5 and plus 5, or between minus 10% and plus 10%.

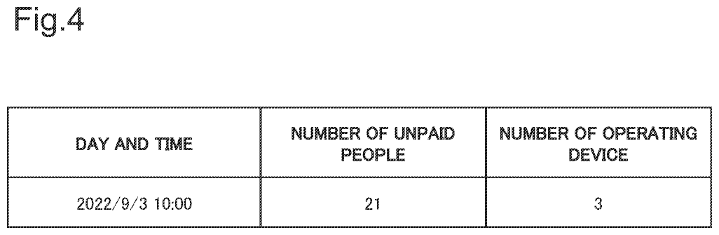

FIG. 4 is an example of data indicating the number of operating devices of the payment devices acquired by the acquisition unit 102 and information indicating the number of unpaid people calculated by the calculation unit 103 at a certain time point. These pieces of data acquired and calculated to predict the demand for the number of operating devices of the payment devices are also referred to as current store data. The specifying unit 104 refers to the storage unit 101 to specify past store data in which the number of unpaid people and the number of operating devices similar to the number of currently unpaid people and the number of currently operating devices are associated with each other based on the current store data illustrated in FIG. 4.

For example, the specifying unit 104 specifies, as past store data including the number of unpaid people and the number of operating devices that are most similar to the current store data illustrated in FIG. 4, which is 21 unpaid peoples and 3 operating devices, data of 9:01 on Nov. 3, 2021, which is 22 unpaid peoples and 3 operating devices, from the past store data illustrated in FIG. 3. Next to the most similar past data, the specifying unit 104 may further specify data of 9:08 on Nov. 3, 2021, which is unpaid people and 3 operating devices, as the past store data including the number of unpaid people and the number of operating devices similar to the number of currently unpaid people and the number of currently operating devices.

The determination unit 105 is an example of a determination means that determines the number of required devices, which is the number of necessary payment devices, based on the specified store data. More specifically, the determination unit 105 determines the number of required devices based on store data from a time point indicated by the specified store data to a time point after a predetermined time. The output control unit 106 causes the output device to output the determined number of required devices. The output device may be, for example, a display device such as a display, a voice output device, or a terminal device.

As the predetermined time, a time at which the number of unpaid people and the number of operating devices of the payment devices at the time point indicated by the specified store data are considered to affect the number of waiting people for payment devices may be set in advance. The time during which the number of unpaid people and the number of operating devices of the payment devices are considered to affect the number of waiting people for payment devices is, for example, an average value of the time from entry of a customer into a store to determination of a purchased product and payment. The predetermined time may be, for example, 10 minutes, 15 minutes, 30 minutes, 1 hour, or the like. The predetermined time may be set in advance based on the tendency of the customer for each time zone such as morning, daytime, evening, night, and midnight.

For example, the determination unit 105 determines the number of required devices based on the number of waiting people in the store data after a predetermined time from a time point indicated by the specified store data, the number of operating devices in the store data during a period from the time point to a predetermined time, and an allowable range of the number of waiting people set in advance. As the allowable range of the number of waiting people, for example, an upper limit value is set so as not to make the customer wait too long at the time of payment. An upper limit value and a lower limit value may be set as the allowable range of the number of waiting people. By setting the lower limit value of the allowable range of the number of waiting people, it is possible to prevent wasteful operation of the payment device.

Specifically, the determination unit 105 compares the allowable range with the number of waiting people in the store data after a predetermined time from the time point indicated by the specified store data. In a case where the number of waiting people included in the store data after a predetermined time from the time point is within the allowable range, the determination unit 105 determines, as the number of required devices, the number of operating devices in the store data during a period from the time point to the predetermined time.

For example, in a case where the number of waiting people included in the store data after a predetermined time from the time point is within the allowable range, and the number of operating devices does not change and remains the same number of operating devices during a period from the time point to the predetermined time, the number of required devices may be the number of currently operating devices. In this case, the output control unit 106 may cause the output device to output information indicating that the number of operating devices does not need to be changed.

For example, in a case where the number of waiting people included in the store data after a predetermined time from the time point is within the allowable range, and the number of operating devices increases or decreases from the number of operating devices at the time point during the period from the time point to the predetermined time, the number of required devices may be the number of operating devices after the increase or decrease during the period from the time point to the predetermined time. For example, in a case where the number of operating devices at the time point is 3 and the number of operating devices increases to 4 at any time point between the time point and a predetermined time later, the determination unit 105 may determine the number of required devices to be 4.

The determination unit 105 may determine the number of required devices including a temporal change. This is because it is considered that the number of required devices increases or decreases within a predetermined time. For example, in a case where the number of waiting people included in the store data after the predetermined time from the time point is within the allowable range, and the number of operating devices increases or decreases from the number of operating devices at the time point during the period from the time point to the predetermined time, the determination unit 105 determines the number of required devices after a period from the time point to a time point when the number of operating devices increases or decreases to be the number of operating devices which has increased or decreased. In this case, the output control unit 106 may cause the output device to output an instruction to increase or decrease the number of operating devices by the same number after the time from the time point to the time point when the number of operating devices increases or decreases elapses based on the number of required devices including the temporal change. For example, in a case where the number of operating devices at the time point is 3, and the number of operating devices is increased to 4 at a time point after 3 minutes, which is a time point between the time point and a predetermined time later, the determination unit 105 may determine the number of required devices after 3 minutes as 4.

When the number of operating devices changes a plurality of times during the period from the time point to the predetermined time later, at least one of the number of operating devices during the period from the time point to the predetermined time later may be selected. In a case where the number of waiting people included in the store data after a predetermined time from the time point is within the allowable range, and the number of operating devices increases or decreases from the number of operating devices at the time point during the period from the time point to the predetermined time, a change including an increase or decrease in the number of operating devices from the time point to the predetermined time may be determined as the number of required devices. For example, in a case where the number of operating devices at the time point is 3, and the number of operating devices increases to 4 and further the number of operating devices returns to 3 during the period from the time point to the predetermined time after the time point, the determination unit 105 may determine the number of required devices to be 4. Alternatively, in this case, in a case where the time during which the number of operating devices was 4 during the period from the time point to the predetermined time is 5 minutes after 2 minutes from the time point, the determination unit 105 may 105 determine that the number of required devices for 5 minutes after 2 minutes is 4. For example, in a case where the number of operating devices at the time point is 3, and the number of operating devices increases to 4 and further increases to 5 during the period from the time point to the predetermined time later, the determination unit 105 may determine the number of required devices as 4, 5, or 4 or 5. In this case, the determination unit 105 may determine both the times from the time point to the time point when the number of operating devices increases. For example, the determination unit 105 may determine that the number of required devices is 4 after 3 minutes and 5 after 7 minutes.

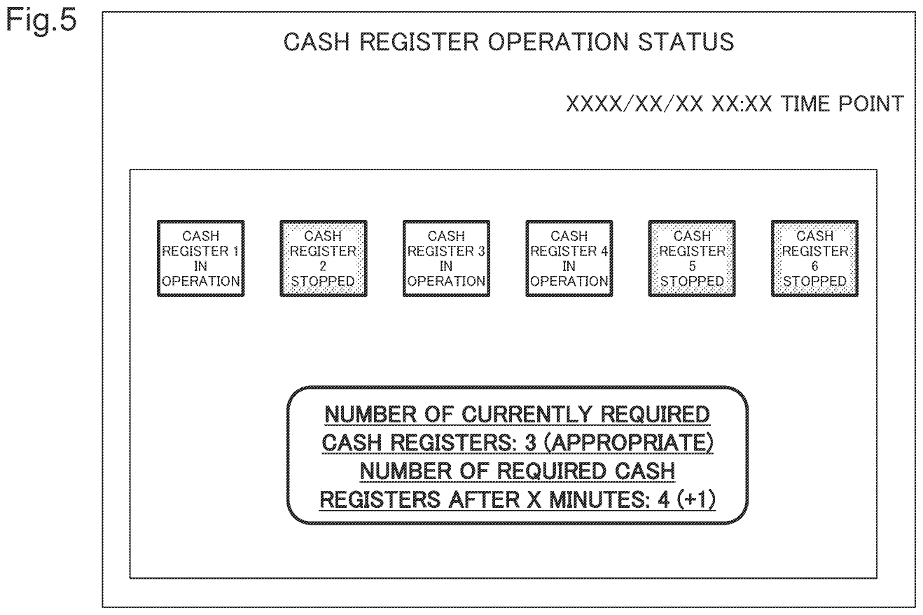

FIG. 5 is a diagram illustrating an output example of the number of required devices. As described above, based on the number of required devices determined by the determination unit 105, the output control unit 106 causes the output device to output information indicating the number of required devices. In FIG. 5, the payment device is referred to as a cash register. In FIG. 5, the number of required cash registers at a certain time point and the number of required cash registers after X minutes are displayed. As illustrated in FIG. 5, in a case where the determination unit 105 determines the number of currently operating devices as the number of required devices, the output control unit 106 may cause the output device to output information indicating that the number of required cash registers at a certain time point (at present) is appropriate and there is no need to increase or decrease the number of cash registers. Further, the output control unit 106 may cause the output device to output information indicating a difference between the number of required devices and the number of currently operating devices instead of the number of required devices. For example, as illustrated in FIG. 5, the output control unit 106 may cause the output device to output information indicating that the number of required cash registers increases by one after X minutes from a certain time point (present). The output control unit 106 may cause the output device to output an instruction such as “increase the number of operating cash registers by one after X minutes”, for example, instead of the number of required devices. The output example is not limited to this example, and similar contents may be output by voice, for example.

In a case where the number of waiting people included in the store data after the predetermined time from the time point is outside the allowable range, the determination unit 105 performs the determination by calculating the number of required devices based on the number of waiting people included in the store data after the predetermined time from the time point. For example, in a case where the number of operating devices in the store data during a period from the time point to a predetermined time later does not change, the determination unit 105 proportionally divides the number of waiting people after the predetermined time from the time point by the number of operating devices, thereby determining the number of required devices. In this case, the output control unit 106 may cause the output device to output an instruction to increase or decrease the number of operating devices so that the number of operating devices becomes the number of calculated and required device.

Alternatively, in a case where the number of waiting people included in the store data after a predetermined time from the time point is outside the allowable range, the determination unit 105 may reduce the number of required devices to be smaller than the number of operating devices when the number of waiting people falls below the allowable range. Conversely, in this case, the determination unit 105 may increase the number of required devices to be larger than the number of operating devices when the number of waiting people exceeds the allowable range. At this time, the number of devices to be reduced and the number of devices to be increased may be a preset number of devices. For example, the number of devices to be reduced or the number of devices to be increased may be one or two, and may be set according to the number of payment devices provided in the store.

Furthermore, in this case, when the number of waiting people after a predetermined time from the time point falls below the allowable range, and the number of operating devices included in at least one piece of store data during the period from the time point to the predetermined time is larger than the number of operating devices at the time point, the determination unit 105 may determine the number of currently operating devices as the number of required devices. Conversely, when the number of waiting people after a predetermined time from the time point exceeds the allowable range, and the number of operating devices included in the at least one piece of store data during the period from the time point to the predetermined time is smaller than the number of operating devices at the time point, the determination unit 105 may determine the number of currently operating devices as the number of required devices. In this way, the determination unit 105 can easily determine the number of required devices to avoid falling outside the allowable range with reference to the number of operating devices in a case where the number of waiting people falls outside the allowable range.

The determination unit 105 determines the number of required devices within a range up to the number of payment devices provided in the store.

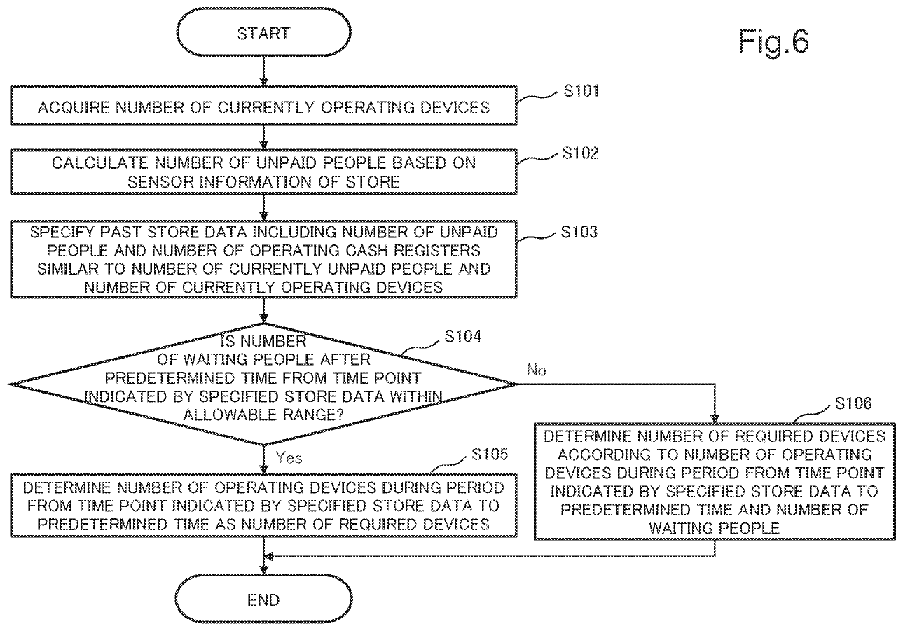

The operation of the information processing apparatus 100 configured as described above will be described with reference to a flowchart of FIG. 6.

FIG. 6 is the flowchart illustrating an outline of the operation of the information processing apparatus 100 according to the example embodiment.

As illustrated in FIG. 6, first, the acquisition unit 102 acquires the number of currently operating devices of the payment devices based on the POS data (Step S101).

Next, the calculation unit 103 calculates the number of unpaid people based on the sensor information of the store (Step S102). Either the processing in Step S101 or the processing in Step S102 may be performed first, or the processing in Step S101 and the processing in Step S102 may be performed simultaneously.

Next, the specifying unit 104 refers to the storage unit 101 to specify past store data including the number of unpaid people and the number of operating devices, which are similar to the number of currently unpaid people and the number of currently operating devices (Step S103).

Next, the determination unit 105 determines whether the number of waiting people for the payment device after a predetermined time from the time point indicated by the specified store data is within an allowable range (Step S104).

Then, when the number of waiting people for the payment device after the predetermined time from the time point indicated by the specified store data is within the allowable range (Step S104: Yes), the determination unit 105 determines the number of operating devices during the period from the time point indicated by the specified store data to the predetermined time as the number of required devices (Step S105).

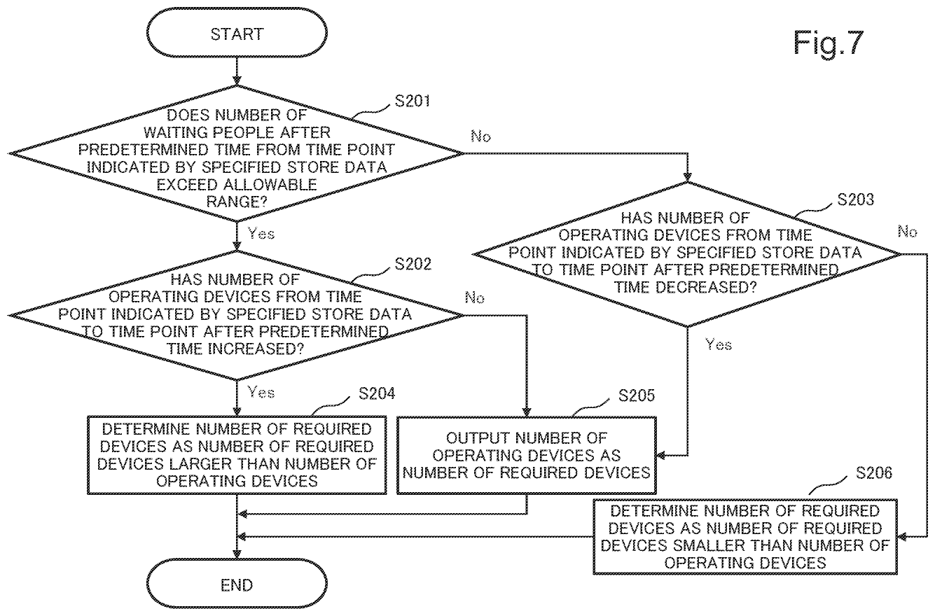

In a case where the number of waiting people for the payment device after the predetermined time from the time point indicated by the specified store data is out of the allowable range (Step S104: No), the determination unit 105 determines the number of required devices according to the number of operating devices during the period from the time point indicated by the specified store data to the predetermined time and the number of waiting people after the predetermined time from the time point indicated by the specified store data (Step S106). An example of more specific processing of Step S106 will be described with reference to FIG. 7.

Thus, the information processing apparatus 100 ends the series of operations. A series of these operations may be performed at predetermined intervals. For example, the series of operations may be performed with an increase in the number of store visitors as a trigger. Furthermore, the output control unit 106 may cause the output device to appropriately output the number of required devices determined in Step S105 or Step S106, or information such as the number of increase devices, the number of decrease devices, the instruction to increase the number of clerks, and the instruction to decrease the number of clerks according to the number of required devices.

FIG. 7 is a flowchart illustrating an example of specific processing in Step S106 described above.

First, in a case where No in Step S104, that is, in a case where the number of waiting people for the payment device after a predetermined time from the time point indicated by the specified store data is outside the allowable range, the determination unit 105 determines whether the number of waiting people for the payment device included in the store data after the predetermined time from the time point indicated by the specified store data exceeds the allowable range (Step S201).

In a case where it is determined that the number of waiting people for the payment device included in the store data after the predetermined time from the time point indicated by the specified store data exceeds the allowable range (Step S201: Yes), the determination unit 105 determines whether the number of operating devices has increased in the store data from the time point indicated by the specified store data to the time point after the predetermined time (Step S202). Here, whether the number has increased is whether the number of operating devices has increased at any time point in a plurality of pieces of store data from the time point indicated by the specified store data to the time point after a predetermined time.

In a case where it is determined that the number of waiting people for the payment device included in the store data after the predetermined time from the time point indicated by the specified store data does not exceed the allowable range, that is, falls below the allowable range (Step S201: No), the determination unit 105 determines whether the number of operating devices has decreased in the store data from the time point indicated by the specified store data to the time point after the predetermined time (Step S203). Similarly to Step S202, whether the number has decreased is whether the number of operating devices has decreased at any time point in the plurality of pieces of store data from the point in time indicated by the specified store data to the point in time after a predetermined time.

In a case where the number of waiting people after the predetermined time period from the time point indicated by the specified store data exceeds the allowable range and the number of operating devices increases from the time point indicated by the specified store data to the predetermined time period (Step S202: Yes), the determination unit 105 determines the number of required devices to be larger than the number of operating devices from the time point indicated by the specified store data to the time point after the predetermined time (Step S204). For example, in a case where the number of operating devices increases from 3 to 4 during the period from the time point indicated by the specified store data to the time point after the predetermined time, and the number of waiting people from the time point indicated by the specified store data to the time point after the predetermined time exceeds the allowable range, the determination unit 105 may determine the number of required devices as 5.

In a case where the number of waiting people after the predetermined time from the time point indicated by the specified store data exceeds the allowable range, and the number of operating devices has not increased after the predetermined time from the time point indicated by the specified store data (Step S202: No), the determination unit 105 determines the number of operating devices from the time point indicated by the specified store data to the time point after the predetermined time period as the number of required devices. In a case where the number of waiting people after a predetermined time from the time point indicated by the specified store data falls below the allowable range and the number of operating devices decreases from the time point indicated by the specified store data to the predetermined time (Step S203: Yes), similarly, the determination unit 105 determines the number of operating devices from the time point indicated by the specified store data to the time point after the predetermined time as the number of required devices (Step S205).

In a case where the number of waiting people after the predetermined time from the time point indicated by the specified store data falls below the allowable range, and the number of operating devices has not decreased by the predetermined time from the time point indicated by the specified store data (Step S203: No), the determination unit 105 determines the number of required devices to be smaller than the number of operating devices from the time point indicated by the specified store data to the time point after the predetermined time (Step S206). For example, in a case where the number of operating devices decreases from 3 to 2 from the time point indicated by the specified store data to the time point after the predetermined time, and the number of waiting people at the time point after the predetermined time from the time point indicated by the specified store data falls below an allowable range, the determination unit 105 may determine the number of required devices as one.

As described above, the information processing apparatus 100 ends the series of operations in Step S106 described above.

In the information processing apparatus according to the present example embodiment described above, the specifying unit specifies the past store data in which the number of unpaid people and the number of operating devices similar to the number of currently unpaid people and the number of currently operating devices are associated with each other. The determination unit determines the number of required devices, which is the number of required payment devices, based on the specified store data.

As described above, the information processing apparatus according to the present example embodiment calculates the number of required devices of payment devices based on the past store data in which the number of unpaid people and the number of operating devices similar to the number of currently unpaid people and the number of currently operating devices e are associated with each other, and thus does not require complicated calculation. As a result, the information processing apparatus according to the present example embodiment can predict the demand for the number of operating devices of payment devices while suppressing the load of arithmetic processing.

### First Modification

In the information processing apparatus 100 according to the example embodiment, the past store data stored in the storage unit 101 and the current store data for the specifying unit to specify similar store data may include other information. That is, the information processing apparatus 100 may determine the number of required devices by specifying the past store data having similar store data other than the number of unpaid people and the number of operating devices.

For example, the store data may further include information indicating a person in charge of operating the payment device at each of the plurality of time points. In this case, the acquisition unit 102 acquires a person in charge of each currently operating payment device from the POS data. The payment required time information of each person in charge is acquired. The payment required time information may be included in the POS data, may be calculated from the POS data, or may be stored in advance in another database. Then, the specifying unit 104 may specify past store data having similar payment required time information of the person in charge of the currently operating payment device in addition to the number of unpaid people and the number of operating devices.

The time required for the operation of the payment device may vary depending on the skill of the person in charge even in the same operation. That is, the person in charge of the payment device affects the number of waiting people for the payment device. Therefore, it is possible to determine the number of required devices with higher accuracy by taking into account the person in charge of the payment device and the person in charge and the payment required time of each person in charge.

For example, the store data may include at least one of the day of the week and the presence or absence of an event at each of a plurality of time points. The event may be, for example, a limited-time sale in which a price is reduced in a certain time zone, a sales promotion plan held according to a day of the week or a date, or the like. In this case, the acquisition unit 102 acquires the day of the week at the current time point. The acquisition unit 102 acquires the presence or absence of an event based on the date, the day of the week, or the time at the current time point. The presence or absence of the event may be stored in advance in association with the date, the day of the week, or the time. Then, the specifying unit 104 may specify past store data in which at least one of the current day of the week and the presence or absence of an event is similar, in addition to the number of unpaid people and the number of operating devices.

In a retail store, the tendency of the number of customers and the number of purchases may differ depending on the day of the week. For example, in a case where there are many customers who come to shop alone on weekdays, but there are many customers who come to shop with a plurality of people such as family members on Saturday, Sunday, and holiday, the relationship between the number of unpaid people and the number of times of completion of payment of the payment device may be different depending on whether it is a weekday or a Saturday, Sunday, and holiday. Since the event is performed to attract customers and promote purchases, in a case where there is an event, an increase in the time required for payment due to an increase in the number of purchases or an increase in the number of customers is expected on the day or in the time zone. That is, the day of the week and the presence or absence of the event affect the number of waiting people of the payment device. Therefore, it is possible to determine the number of required devices with higher accuracy by considering at least one of the day of the week and the presence or absence of the event.

For example, the specifying unit 104 may specify past store data belonging to the same time zone as the current time point among store data including the number of unpaid people and the number of operating devices, which are similar to the number of currently unpaid people and the number of currently operating devices. The information indicating the time zone may be stored in advance in another database. Alternatively, the store data stored in the storage unit 101 may further include information indicating a time zone at each time point. The time zone may be divided into, for example, a morning, a daytime, an evening, and a night, which are time zones with different customer tendencies. In the retail store, similarly to the day of the week, the tendency of the number of customers and the number of products purchased may be different depending on the time zone. Therefore, it is possible to determine the number of required devices with higher accuracy by taking the time zone into consideration.

The store data described above may be combined.

### Second Modification

In the information processing apparatus 100 according to the example embodiment, a plurality of pieces of store data may be specified by the specifying unit 104.

In a case where there are a plurality of pieces of specified store data, the determination unit 105 may determine the number of required devices based on the number of operating devices and the number of waiting people in the store data having a high matching rate with the current store data among the plurality pieces of specified store data. By using past store data having a high matching rate, it is possible to more accurately determine the number of required devices.

In a case where there are the plurality of pieces of specified store data, the determination unit 105 may determine the number of required devices based on each of the plurality of pieces of specified store data and the number of operating devices and the number of waiting people included in each piece of store data. In this case, for example, the output control unit 106 may cause the output device to output a plurality of candidates of the number of required devices, such as 2 or 3. Alternatively, in a case where there are a plurality of pieces of specified store data, the output control unit 106 may cause the output device to output the plurality of pieces of specified store data and the range of the number of required devices based on the number of operating devices and the number of waiting people included in each piece of store data. In this case, for example, the output control unit 106 may cause the output device to output the range of the number of required devices, such as 2 to 4.

In this manner, by determining the plurality of required devices, the clerk can consider the number of devices to be operated based on the information. In this case, the output control unit 106 may cause the output device to further output the matching rate of the current store data of each piece of the store data used to determine the required number for each of the plurality of required devices, and at least one item with a high matching rate. By outputting the matching rate and at least one item having a high matching rate, the clerk can consider the number of devices to be operated based on the information.

### Hardware Configuration

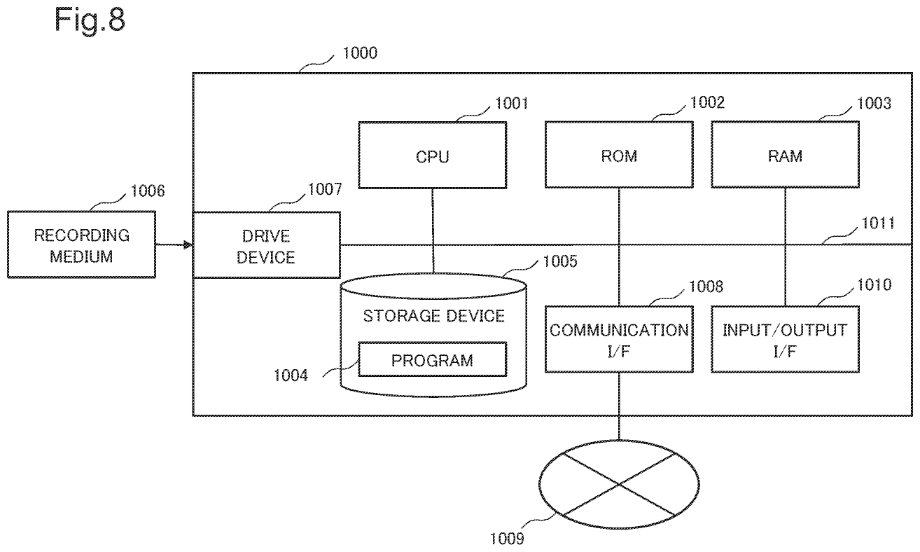

Some or all of components of each apparatus or system in each example embodiment of the present disclosure described above is achieved by, for example, an arbitrary combination of the information processing apparatus 1000 and a program as illustrated in FIG. 8. The information processing apparatus 1000 includes the following configuration as an example.
CPU(Central Processing Unit) 1001
ROM(Read Only Memory) 1002
RAM(Random Access Memory) 1003
Program 1004 loaded into RAM 1003
Storage device 1005 storing program 1004
Drive device 1007 that reads and writes recording medium 1006
Communication I/F 1008 connected to communication network 1009
Input/output I/F 1010 for inputting/outputting data
Bus 1011 connecting each component

The I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the implementation method of each device. For example, each device or system may be achieved by an arbitrary combination of the information processing apparatus 1000 and the program separate for each component. A plurality of components included in each device may be achieved by an arbitrary combination of one information processing apparatus 1000 and a program.

Some or all of the components of each device or system are achieved by general-purpose or dedicated circuitry including a processor or the like, or a combination thereof. The circuitry is, for example, a CPU, a graphics processing unit (GPU), a field programmable gate array (FPGA), or a large scale integration (LSI). These may be configured by a single chip or may be configured by a plurality of chips connected via a bus. Some or all of the components of each device may be achieved by a combination of the above-described circuitry or the like and a program.

In a case where some or all of components of each device or system are achieved by a plurality of information processing apparatuses, circuits, and the like, the plurality of information processing apparatuses, circuits, and the like may be arranged in a centralized manner or in a distributed manner. For example, the information processing apparatus, the circuit, and the like may be achieved as a form in which each is connected via a communication network, such as a client and server system or a cloud computing system.

A plurality of payment devices may be provided in a store. In this case, some of the payment devices may be operated according to the number of customers who visit the store and the number of working clerks. It is important to operate an appropriate number of payment devices in order to make a waiting time until a customer makes a payment and the number of clerks who handle the payment devices appropriate.

For example, using simulation or machine learning to predict congestion based on a large amount of information would result in a large computational load.

An example advantage according to the invention is that it is possible to perform demand prediction of the number of operating devices of the payment devices while suppressing a load of arithmetic processing. The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Various modifications that can be understood by those skilled in the art can be made to the configuration and details of the present disclosure within the scope of the present disclosure.

Although the plurality of operations are described in order in the form of a flowchart, the order of description does not limit the order of executing the plurality of operations. Therefore, when each example embodiment is implemented, the order of the plurality of operations may be changed within a range that does not interfere in content. Further, it is noted that the inventor's intent is to retain all equivalents of the claimed invention even if the claims are amended during prosecution.

### Supplementary Note

Some or all of the above example embodiments may be described as the following Supplementary Notes, but are not limited to the following.

### (Supplementary Note 1)

An information processing apparatus including:

a storage means that stores store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points;

an acquisition means that acquires the number of currently operating devices;

a calculation means that calculates the number of currently unpaid people based on the sensor data of the store;

a specifying means that specifies past store data in which the number of unpaid people and the number of operating devices similar to the number of currently unpaid people and the number of currently operating devices are associated with each other; and

a determination means that determines the number of required devices which is the number of required payment devices based on the specified store data.

### (Supplementary Note 2)

The information processing apparatus according to Supplementary Note 1, in which the determination means determines the number of required devices based on the number of waiting people in the store data after a predetermined time from a time point indicated by the specified store data, the number of operating devices in the store data during a period from the time point to a predetermined time, and an allowable range of the number of waiting people set in advance.

### (Supplementary Note 3)

The information processing apparatus according to Supplementary Note 2, in which the determination means determines, when the number of waiting people included in the store data after the predetermined time from the time point is within the allowable range, the number of operating devices in the store data during the period from the time point to the predetermined time is determined as the number of required devices.

### (Supplementary Note 4)

The information processing apparatus according to Supplementary Note 2 or 3, in which the determination means performs determination by calculating, when the number of waiting people included in the store data after the predetermined time from the time point is outside the allowable range, the number of required devices based on the number of waiting people included in the store data after the predetermined time from the time point.

### (Supplementary Note 5)

The information processing apparatus according to any one of Supplementary Notes 2 to 4, in which the determination means determines, when the number of waiting people after the predetermined time from the time point is below the allowable range and the number of operating devices of at least one piece of store data included in the store data after the predetermined time from the time point is larger than the number of operating devices at the time point, the number of currently operating devices as the number of required devices.

### (Supplementary Note 6)

The information processing apparatus according to any one of Supplementary Notes 2 to 5, in which the determination means determines, when the number of waiting people after the predetermined time from the time point exceeds the allowable range and the number of operating devices of at least one piece of store data included in the store data after the predetermined time from the time point is smaller than the number of operating devices at the time point, the number of currently operating devices as the number of required devices.

### (Supplementary Note 7)

The information processing apparatus according to any one of Supplementary Notes 1 to 6, in which the acquisition means further acquires the number of times of completion, which is the number of times that the payment device in the store completes the payment, and

the calculation means calculates the number of currently unpaid people based on a total value of the number of customers who have entered the store from a time of opening the store to the present and a total value of the number of times of completion from the time of opening the store to the present, which are detected in the store.

### (Supplementary Note 8)

The information processing apparatus according to any one of Supplementary Notes 1 to 7, in which the store data further includes at least one of a person in charge of operation of each of the payment devices at the time point and payment required time information indicating a payment required time that is a time taken for payment by the person in charge,

the acquisition means acquires at least one of a person in charge of each currently operating payment device and current payment required time information, and

the specifying means specifies the past store data similar to the current payment required time information of the current person in charge of the currently operating payment device, in addition to the number of currently unpaid people and the number of currently operating devices.

### (Supplementary Note 9)

The information processing apparatus according to any one of Supplementary Notes 1 to 8, in which the store data further stores at least one of a day of the week and presence or absence of an event at the time point, as the store data,

the acquisition means acquires at least one of a current day of a week and presence or absence of a current event, and

the specifying means specifies the past store data similar to at least one of the current day of the week and the presence or absence of the current event, in addition to the number of currently unpaid people and the number of currently operating devices.

### (Supplementary Note 10)

The information processing apparatus according to any one of Supplementary Notes 1 to 9, in which the specifying means specifies the past store data belonging to the same time zone as the current time point among the store data including the number of unpaid people and the number of operating devices similar to the number of currently unpaid people and the number of currently operating devices.

### (Supplementary Note 11)

The information processing apparatus according to any one of Supplementary Notes 1 to 10, in which the determination means determines, as the number of required devices, the number of required devices based on the number of operating devices and the number of waiting people in the store data having a high matching rate with the current store data among the plurality of pieces of specified store data.

### (Supplementary Note 12)

The information processing apparatus according to any one of Supplementary Notes 1 to 11, in which the determination means determines the number of the plurality of required devices based on the plurality of pieces of specified store data and the number of operating devices and the number of waiting people included in each of the pieces of store data.

### (Supplementary Note 13)

The information processing apparatus according to Supplementary Note 12 further including an output control means that causes an output device to output information indicating the number of required devices to an output device,

in which the output control means further outputs at least one of a matching rate of the current store data of each of the specified store data and information indicating an item having a high matching rate.

### (Supplementary Note 14)

An information processing method by a computer storing, in a storage unit, store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points, the information processing method including:

acquiring the number of currently operating devices;

calculating the number of currently unpaid people based on the sensor data of the store; specifying past store data in which the number of unpaid people and the number of operating devices similar to the number of currently unpaid people and the number of currently operating devices are associated with each other; and

determining the number of required devices which is the number of required payment devices based on the specified store data.

### (Supplementary Note 15)

A recording medium that stores a program for causing a computer communicably connected to a storage unit storing store data including the number of unpaid people, which is the number of customers who are unpaid in a store, the number of operating devices, which is the number of operating payment devices, and the number of waiting people, which is the number of customers who are waiting for payment in the payment devices, at each of a plurality of time points, to execute:

acquiring the number of currently operating devices;

calculating the number of currently unpaid people based on the sensor data of the store; specifying past store data in which the number of unpaid people and the number of operating devices similar to the number of currently unpaid people and the number of currently operating devices are associated with each other; and

determining the number of required devices which is the number of required payment devices based on the specified store data.

1. An information processing apparatus comprising:
a memory storing instructions, and storing store data including a number of unpaid customers who are unpaid in a store, the number of operating payment devices, and the number of waiting customers waiting for payment in a payment devices, at each of a plurality of time points; and
one or more processors configured to execute the instructions to:
acquire the number of currently operating payment devices;
calculate the number of currently unpaid customers based on a sensor data of the store;
specify past store data in which the number of unpaid customers and the number of operating payment devices similar to the number of currently unpaid customers and the number of currently operating payment devices are associated with each other; and
determine the number of required payment devices based on the specified store data.

2. The information processing apparatus according to claim 1, wherein
the one or more processors are further configured to execute the instructions to:
determine the number of required payment devices based on the number of waiting customers in a store data after a predetermined time from a time point indicated by the specified store data, the number of operating payment devices in the store data during a period from the time point to the predetermined time, and an allowable range of the number of waiting customers set in advance.

3. The information processing apparatus according to claim 2, wherein
the one or more processors are further configured to execute the instructions to:
determine, when the number of waiting customers included in the store data after the predetermined time from the time point is within the allowable range, the number of operating payment devices in the store data during the period from the time point to the predetermined time as the number of required payment devices.

4. The information processing apparatus according to claim 2, wherein
the one or more processors are further configured to execute the instructions to:
calculate, when the number of waiting customers included in the store data after the predetermined time from the time point is outside the allowable range, the number of required payment devices based on the number of waiting customers included in the store data after the predetermined time from the time point.

5. The information processing apparatus according to claim 2, wherein
the one or more processors are further configured to execute the instructions to:
determine, when the number of waiting customers after the predetermined time from the time point is below the allowable range and the number of operating payment devices of at least one piece of store data included in the store data after the predetermined time from the time point is larger than the number of operating payment devices at the time point, the number of currently operating payment devices as the number of required payment devices.

6. The information processing apparatus according to claim 2, wherein
the one or more processors are further configured to execute the instructions to:
determine, when the number of waiting customers after the predetermined time from the time point exceeds the allowable range and the number of operating payment devices of at least one piece of store data included in the store data after the predetermined time from the time point is smaller than the number of operating payment devices at the time point, the number of currently operating payment devices as the number of required payment devices.

7. The information processing apparatus according to claim 1, wherein
the one or more processors are further configured to execute the instructions to:
further acquire the number of times of payment completion, which is the number of times that the payment device in the store completes the payment; and
calculate the number of currently unpaid customers based on a total value of the number of customers who have entered the store from a time of opening the store to the present and a total value of the number of times of the payment completion from the time of opening the store to the present, which are detected in the store.

8. The information processing apparatus according to claim 1,
wherein
the store data further includes at least one of a person in charge of operation of each of the payment devices at the time point and payment required time information indicating a payment required time that is a time taken for payment by the person in charge, and
the one or more processors are further configured to execute the instructions to:
acquire at least one of a person in charge of each currently operating payment device and current payment required time information; and
specify the past store data similar to the current payment required time information of the current person in charge of the currently operating payment device, in addition to the number of currently unpaid customers and the number of currently operating devices.

9. The information processing apparatus according to claim 1,
wherein
the store data further includes at least one of a day of the week and presence or absence of an event at the time point; and
the one or more processors are further configured to execute the instructions to:
acquire at least one of a current day of a week and presence or absence of a current event; and
specify the past store data similar to at least one of the current day of the week and the presence or absence of the current event, in addition to the number of currently unpaid customers and the number of currently operating devices.

10. The information processing apparatus according to claim 1, wherein
the one or more processors are further configured to execute the instructions to:
specify a past store data belonging to a same time zone as a current time point among the store data including the number of unpaid customers and the number of operating payment devices similar to the number of currently unpaid customers and the number of currently operating payment devices.

11. The information processing apparatus according to claim 1, wherein
the one or more processors are further configured to execute the instructions to:
determine, as the number of required payment devices, the number of required payment devices based on the number of operating payment devices and the number of waiting customers in the store data having a high matching rate with the current store data among the plurality of pieces of specified store data.

12. The information processing apparatus according to claim 1, wherein
the one or more processors are further configured to execute the instructions to:
determine the plurality of the number of required payment devices based on the plurality of pieces of specified store data and the number of operating payment devices and the number of waiting customers included in each of the pieces of store data.

13. The information processing apparatus according to claim 12, wherein
the one or more processors are further configured to execute the instructions to:
output information indicating the number of required payment devices to an output device; and
further output at least one of a matching rate of the current store data of each of the specified store data and information indicating an item having a high matching rate.

14. An information processing method by a computer storing store data including the number of unpaid customers who are unpaid in a store, the number of operating payment devices, and the number of waiting customers waiting for payment in a payment devices, at each of a plurality of time points, the information processing method comprising:
acquiring the number of currently operating payment devices;
calculating the number of currently unpaid customers based on a sensor data of the store;
specifying past store data in which the number of unpaid customers and the number of operating payment devices similar to the number of currently unpaid customers and the number of currently operating payment devices are associated with each other; and
determining the number of required payment devices based on the specified store data.

15. A non-transitory computer-readable recording medium that records store data including the number of unpaid customers who are unpaid in a store, the number of operating payment devices, and the number of waiting customers waiting for payment in a payment devices, at each of a plurality of time points, and a program for causing a computer to execute:
acquiring the number of currently operating payment devices;
calculating the number of currently unpaid customers based on a sensor data of the store;
specifying past store data in which the number of unpaid customers and the number of operating payment devices similar to the number of currently unpaid customers and the number of currently operating payment devices are associated with each other; and
determining the number of required payment devices based on the specified store data.
